(19) United States
(12) Patent Application Publication
(10) Pub. No.: US 2002/0162422 A1
(43) Pub. Date: Nov. 7, 2002

(54) 360 degree continous working wrench

(76) Inventor: Rafail Kerzhner, Bloomfield, CT (US)

Correspondence Address: Barry L. Kelmachter, BACHMAN & LaPOINTE, P.C., Suite 1201, 900 Chapel Street, New Haven, CT, 06510-2802, US

(21) Appl. No.: 10/100,629

(22) Filed: Mar. 15, 2002

Related U.S. Application Data
(60) Provisional application No. 60/276,234, filed on Mar. 15, 2001.

(51) Int. Cl. B25B 13/00

(52) U.S. Cl. 81/58.2

(57) ABSTRACT

The present invention relates to a 360 degree continuous working wrench. The wrench comprises a handle with an open-ended portion and a ratchet mechanism within the open-ended portion. The ratchet mechanism is mounted in the open-ended portion for 360 degree rotation. In one embodiment, an indexing arm is provided to cause a driving block to engage the external knurls of the ratchet mechanism during an operation for rotating a member to be loosened or tightened. In a second embodiment of the wrench, an indexing arm and an indexing pin are provided to engage a surface of the member to be tightened or loosened.

### CROSS REFERENCE TO RELATED APPLICATION(S)

This application claims the benefit of U.S. Provisional Patent Application Serial No. 60/276,234, filed Mar. 15, 2001, entitled “A 360 Degree Continuous Working Wrench.”

### BACKGROUND OF THE INVENTION

The present invention relates to a 360 degree continuous working wrench.

Open faced wrenches with ratcheting mechanisms are known in the prior art. U.S. Pat. No. 2,578,686 to Fish, U.S. Pat. No. 1,890,213 to Cameron et al., U.S. Pat. No. 834,219 to Young, U.S. Pat. No. 5,174,176 to Krivec, and U.S. Pat. No. 2,521,419 to Sellers illustrate some of the ratchet wrenches known in the art.

None of these wrenches however are 360 degree continuous work wrenches.

### SUMMARY OF THE INVENTION

Accordingly, it is an object of the present invention to provide a 360 degree continuous work wrench.

The foregoing object is achieved by the wrench of the present invention.

In accordance with the present invention, a 360 degree continuous work wrench is provided. The wrench broadly comprises a handle having a first opening formed by two spaced apart jaws and a ratchet mechanism having a second opening for receiving a portion of a member to be tightened or loosened and an external set of teeth or knurls. The ratchet mechanism is connected to the handle and is movable through 360 degrees of rotation.

In a first embodiment, the wrench further comprises a driving block and an indexing arm for moving the driving block between a first position where the driving block engages the external knurls of the ratchet mechanism and a second position where the driving block is disengaged from the external knurls of the ratchet mechanism.

In a second embodiment, the wrench further comprises an indexing arm provided with an indexing pin for engaging a surface of a member to be tightened or loosened during turning operation of the wrench. The indexing arm may be manually moved to a release position where the indexing pin disengages from the surface of the member so that the wrench may be released from the member being tightened or loosened irrespective of the position of the ratchet mechanism.

Other details of the wrench of the present invention, as well as other objects and advantages attendant thereto, are set forth in the following detailed description and the accompanying drawings in which like reference numerals depict like elements.

### BRIEF DESCRIPTION OF THE DRAWINGS

FIG. 1 is a top view of a first embodiment of a 360 degree continuous work wrench in accordance with the present invention;

FIG. 2 is a sectional view taken along lines 2-2 in FIG. 1;

FIG. 3 is a top view of the wrench of FIG. 1 in a start turning position;

FIG. 4 is a bottom view of the wrench of FIG. 1 in a release position;

FIG. 5 is a top view of a portion of the wrench of FIG. 1;

FIG. 6 is a side view of a second embodiment of a 360° continuous work wrench;

FIG. 7 is a side view of a handle side plate used in the wrench of FIG. 6;

FIG. 8 is a side view of a ratchet used in the wrench of FIG. 6;

FIG. 9 is a side view of a driving block used in the wrench of FIG. 6;

FIG. 10 is a side view of the wrench of FIG. 6 in a start turning position;

FIG. 11 is a partial side view of the front portion of the wrench of FIG. 6; and

FIG. 12 is a sectional view taken along lines 12-12 in FIG. 11.

### DETAILED DESCRIPTION OF THE PREFERRED EMBODIMENT(S)

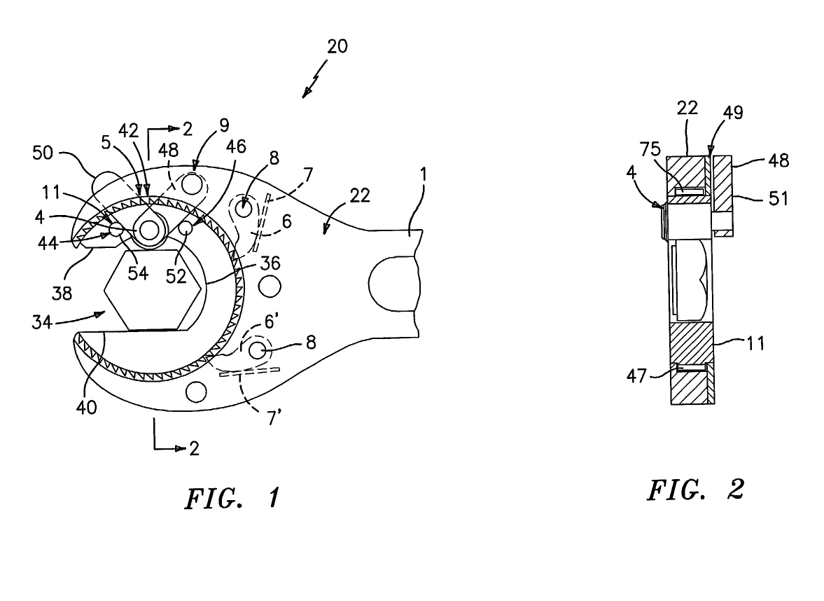

Referring now to the FIGS. 1, 2 and 5 of the drawings, the wrench 20 has a handle portion 1 and an integrally formed open-ended portion 22. The open-ended portion 22 has machined therein an arcuate slot 24, a pair of holes 26 and 28, and machined out portions 30 and 32.

Positioned within the slot 24 is a ratchet mechanism 11. The ratchet mechanism 11 includes an open ended slot 34 which preferably includes an arcuate section 36 extending between planar sections 38 and 40. The ratchet mechanism 11 also includes a plurality of teeth or knurls 42 along an outer surface. The teeth or knurls 42 may be designed to have any desired pitch. The ratchet mechanism 11 also includes a pair of openings 44 and 46 whose purpose will be discussed hereinafter. The wrench 20 is provided with rotation means 47 for allowing the ratchet mechanism 11 to rotate about 360 degrees during use. The rotation means 47 may comprise any suitable rotation facilitating means known in the art, such as a bearing ring. The rotation means 47 is preferably positioned in a slot 75 in the open-ended portion 22 and between a portion of the slot 75 and a cover 51.

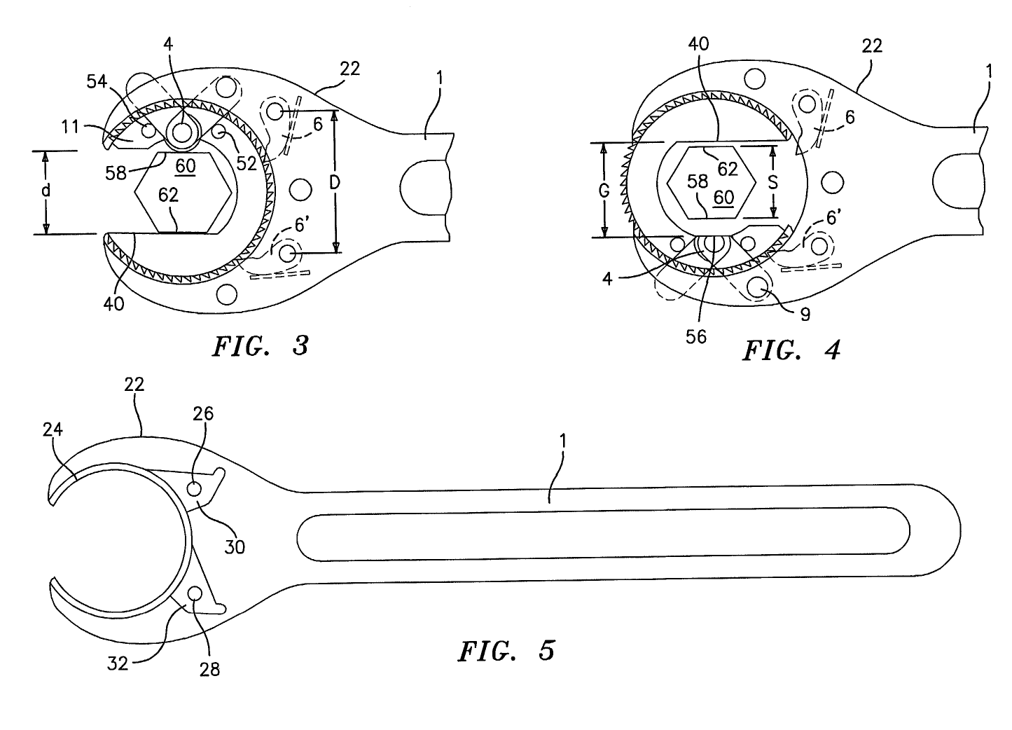

The wrench 20 further includes an indexing arm 5 having a first position 48 and a second position 50. An indexing pin 4 is joined to the arm 5 and is movable between an engaging position shown in FIG. 3 and a release position shown in FIG. 4. The indexing arm 5 is capable of rotatingly moving about the pin 4 between the positions 48 and 50. The indexing pin 4 is held in contact with a surface 58 of a member 60 to be tightened or loosened by a spring (not shown). To move the indexing pin 4 to the release position, the arm 5 is manually engaged so that a force is applied to the pin 4 which opposes the force of the spring.

A pair of pin structures 52 and 54 are positioned within the openings 44 and 46 in the ratchet mechanism 11 to control the positioning of the indexing arm 5.

The wrench 20 further has a pair of spaced apart pawls 6 and 6′ for engaging the teeth 54. Each of the pawls 6 and 6′ is positioned within one of the machined out portions 30 and 32 and connected to the open-ended portion 22 by a pin 8. The pawls 6 and 6′ are capable of rotational movement about the respective pins 8. A pair of back springs 7 and 7′ are provided to insure the proper positioning of the pawls 6 and 6′ during both the turning condition and the release condition. The rotational axes of the pawls 6 and 6′ formed by the pins 8 is preferably separated by a distance D greater than the opening space d in the ratchet mechanism.

As can be seen from FIG. 3, the pin 4 has a flattened surface 56. The pin 4 is provided with the flattened surface 56 so that it can contact a face 58 of a member 60 to be tightened or loosened during a turning operation such as shown in FIG. 3. As shown in FIG. 4, when the indexing arm 5 is moved to a release position, the surface 56 of the pin 4 is spaced away from the face 58 of the member 60.

During a turning mode, the indexing arm 5 is in a position where the pin surface 56 is in contact with the face 58 of the member 60 and the planar surface 40 of the ratcheting mechanism slot 34 contacts a face 62 of the member 60 opposed to the face 58. When it becomes necessary to release the wrench 20, the indexing arm 5 is moved manually by engaging it with the end of a finger to the member release position shown in FIG. 4. Since the slot 34 has a gap G greater than the span S of the member 60, the member 60 can be released from the wrench 20 when the indexing arm 5 has been moved to the release position.

One of the advantages to the wrench of FIGS. 1-5 is that the member being tightened may be released from any position of the wrench. Still further, the wrench of the present invention allows tightening and loosening through a 360 degree range of motion.

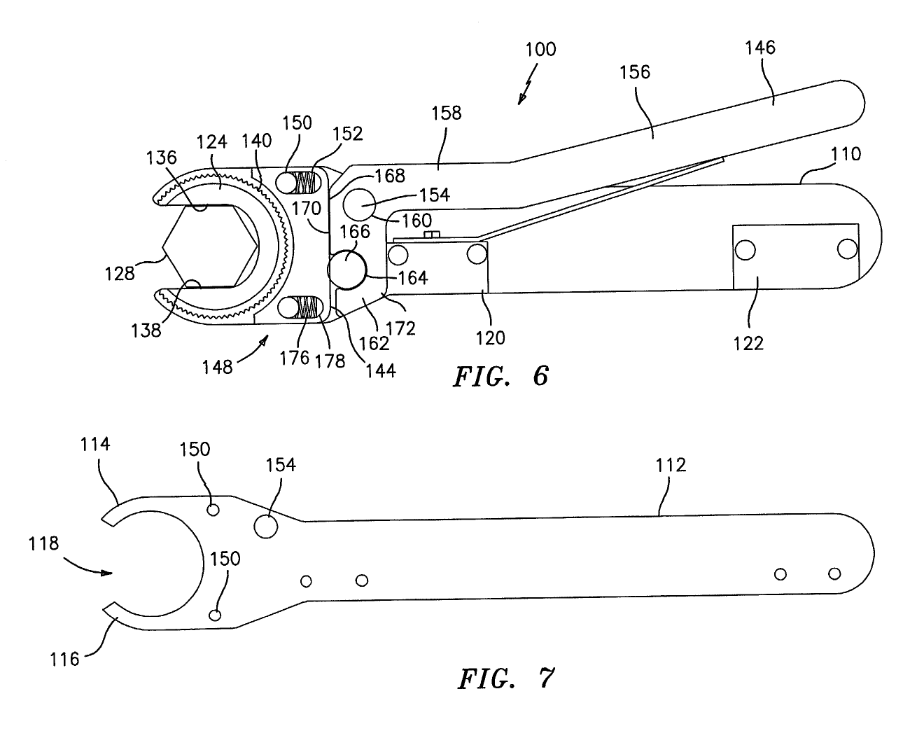

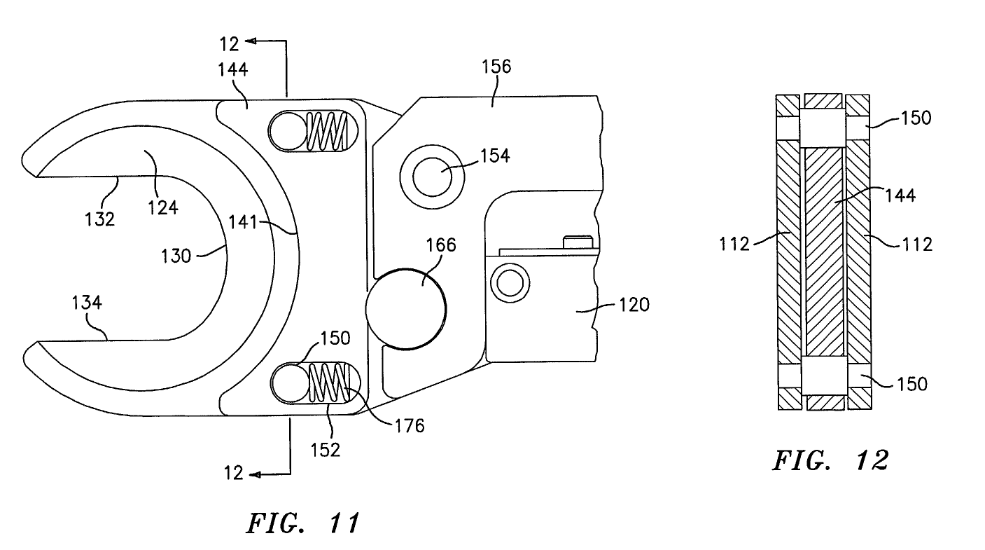

Referring now to FIGS. 6-12, a 360 degree open ratchet actuated wrench 100, which also functions as a pliers, for tightening and loosening bolts and other members is illustrated. The wrench 100 includes a handle 110 formed by a pair of side plates 112. One of the side plates 112 is shown in FIG. 7. As shown, therein, the side plate 112 has a pair of jaws 114 and 116 which define a first opening 118. The handle 110 further includes a pair of support plates 120 and 122 sandwiched between the side plates 112. The side plates 112 and the support plates 120 and 122 may be joined together using any suitable means known in the art. For example, the side plates 112 and support plates 120 and 122 may be joined together by pins, bolts, screws, etc. If desired, the side plates 112 and the support plates 120 and 122 may be welded together.

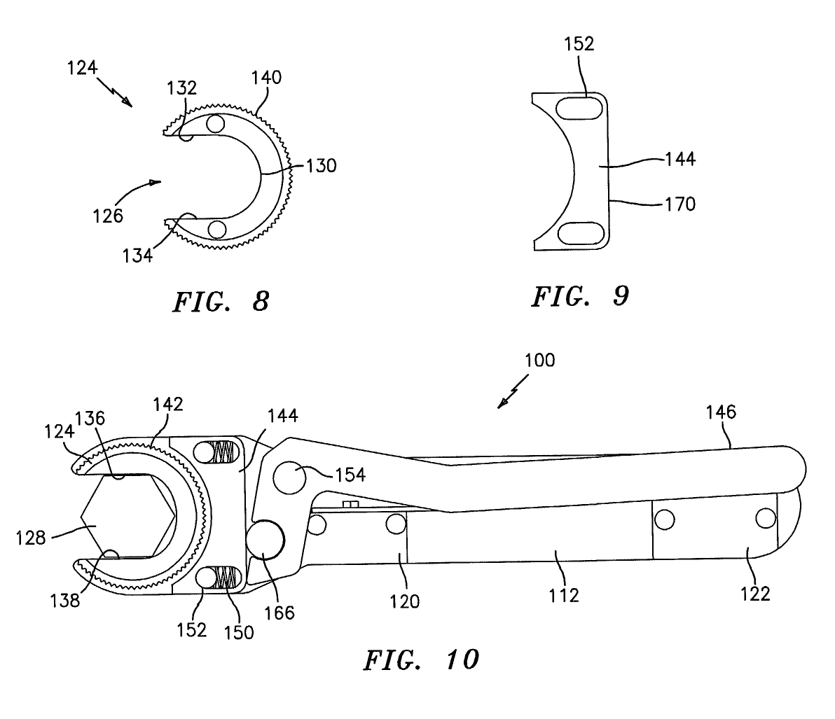

The wrench 100 further includes a ratchet 124 having a second opening 126 in which a member 128 to be loosened or tightened, such as a bolt or nut, can be received. The second opening 126 may have any desired shape or configuration. As shown in FIG. 8, the second opening 126 is formed by an arcuate section 130 joining two planar sections 132 and 134. The planar sections 132 and 134 are used to contact and engage opposed surfaces 136 and 138 of the member 128 and are thus spaced apart by the distance between the surfaces 136 and 138. The ratchet 122 further has a plurality of external knurls 140 in lieu of teeth. The knurls 140 may have any desired shape and/or any desired pitch.

The ratchet 124 is secured to the side plates 112 forming the handle 110 so that it is free to rotate through 360 degrees. Any suitable means known in the art capable of providing this 360 degree rotation may be used to secure the ratchet 124 to the side plates 112. For example, a mechanism may be incorporated into one or more of the side plates 112 to allow the ratchet 124 to rotate relative to the side plates 112. Alternatively, a bearing ring may be used to allow rotation of the ratchet 124. In a preferred embodiment of the present invention, a ratchet indexing block 142 is secured to one of the side plates 112 and positioned intermediate the ratchet 124 and one of the side plates 112.

The wrench 110 further comprises a toothless driving block 144 and an indexing arm 146 for moving the driving block 144 from a first position where the driving block 144 does not engage knurls 140 and a second position where the driving block 144 engages the knurls 140 over a 120 degree arc. As can be seen from FIG. 11, the driving block 144 has a 120 degree curved surface 141 which contacts the knurls 140 when in the second position. The driving block 144 is mounted for reciprocating movement along an axis parallel to the longitudinal axis of the wrench via a pin and slot arrangement 148. As shown in FIG. 11, the arrangement 148 comprises a pair of pins 150 secured to one or more of the side plates 112 and a pair of slots 152. The pins 150 may be integrally formed with one of the side plates 112 or may be separate from but joined to the side plates 112.

The indexing arm 146 is mounted onto a pin 154 for rotational movement relative to the pin. The pin 154 may integrally formed with one of the side plates 112 or may be separate from the side plates 112 but joined thereto. The arm 146 has a first portion 156 to be grasped by a user of the wrench 110, a second portion 158 with a bore 160 for receiving the pin 154, and an actuating portion 162. The actuating portion 162 has a third opening 164 in which a bearing 166 is located. As can be seen from FIG. 6, when the indexing arm is in a release position, a surface 168 of the second portion 158 contacts a surface 170 of the driving block 144. Furthermore, a rear surface 172 of the actuating portion 162 contacts the supporting plate 120.

When the first portion 156 is depressed as shown in FIG. 10, the indexing arm 146 rotates about the axis defined by the pin 154. The resulting movement of the bearing 166 against the surface 170 causes the driving block 144 to move toward and engage the knurls 140 on the ratchet mechanism 124. Continued rotational movement applied to the indexing arm 146 and the handle 110 causes the handle 110 to rotate and start turning the member 128. Depending on which direction the handle 110 is rotated, the member 128 is tightened or loosened.

To return the driving block 144 to its original position, the indexing arm 146 is released. A spring 174 attached to the support plate 120 and the underside of the arm 146 causes the arm 146 to move from the depressed position shown in FIG. 10 to the release position shown in FIG. 6. Springs 176, such as compression springs, cause the driving block 144 to move from its ratchet engaging position to the release position shown in FIG. 6. In a preferred embodiment, each of the springs 176 is located between one of the pins 150 and a rear edge 178 of a slot 152. When the indexing arm 146 and the driving block 144 are in the release positions shown in FIG. 6, the wrench 110 may be rotated with respect to the member 128 without causing the member 128 to be rotated. Further, the ratchet mechanism 124 is free to rotate relative to the handle 110 through a 360 degree range of movement.

One of the advantages to this embodiment of the invention is that there is no mechanism side as in standard wrenches. Further, the wrench 100 may be used on either side. Still further, the wrench 100 functions as a pliers by virtue of the index arm 146 and the driving block 144. This allows a greater force, as much as five times greater than the force which can be applied with a standard wrench, to be applied to a device to be tightened or loosened.

It is apparent that there has been provided in accordance with the present invention a 360 degree continuous working wrench which fully satisfies the objects, means and advantages set forth hereinbefore. While the present invention has been described in the context of specific embodiments thereof, other variations, modifications and alternatives will become apparent to those skilled in the art having read the foregoing description. Therefore, it is intended to embrace such variations, modifications, and alternatives as fall within the broad scope of the appended claims.

What is claimed is:

1. A wrench for tightening and loosening a member, comprising:
a handle having a first opening formed by two spaced apart jaws;
a ratchet mechanism having a second opening for receiving a portion of a member to be tightened or loosened; and
said ratchet mechanism being connected to said handle and being movable through 360 degrees of rotation.

2. A wrench according to claim 1, further comprising:
an indexing arm for movement between an engaged position for rotating said member and a release position.

3. A wrench according to claim 2, further comprising:
said ratchet having an external set of knurls;
a driving block for engaging said ratchet over a 120 degree arc; and
said indexing arm moving said driving block into contact with said external set of knurls when in said engaged position.

4. A wrench according to claim 3, further comprising said indexing arm being pivotally mounted to said handle.

5. A wrench according to claim 4, further comprising:
said handle including a support block; and
a spring attached to said support block for returning said indexing arm from said engaged position to said release position.

6. A wrench according to claim 3, further comprising reciprocating movement enabling means for mounting said driving block to said handle.

7. A wrench according to claim 6, wherein said reciprocating movement enabling means comprising a pair of pins secured to said handle and a pair of slots machined in said driving block for engaging said pair of pins.

8. A wrench according to claim 7, further comprising spring means between each of said pins and an edge of a respective slot for moving said driving block from a ratchet engaging position to a retracted position when said indexing arm is moved between said engaging position and said release position.

9. A wrench according to claim 1, further comprising said ratchet mechanism being connected to said handle by means for enabling rotation of said ratchet mechanism through 360 degrees of rotation.

10. A wrench according to claim 1, wherein said second opening is defined by two planar surfaces connected by an arcuate portion.

11. A wrench according to claim 1, further comprising an indexing arm and an indexing pin joined to said arm for contacting a surface of said member to be tightened or loosened.

12. A wrench according to claim 11, wherein said indexing pin has a flat surface for contacting said member to be tightened or loosened.

13. A wrench according to claim 11, further comprising spring means for holding said indexing pin in contact with said member surface.

14. A wrench according to claim 11, further comprising a pair of pins for controlling the position of said indexing arm.

15. A wrench according to claim 1, further comprising a pair of spaced apart pawls for engaging external teeth on said ratchet.

16. A wrench according to claim 15, further comprising back springs for insuring proper positioning of said pawls during both a wrench turning condition and a wrench release condition.

17. A wrench according to claim 17, wherein each of said pawls rotates about an axis defined by a pin and said pins are separated by a distance greater than an opening space of said ratchet mechanism.
